(19) United States
(12) Patent Application Publication
(10) Pub. No.: US 2014/0098392 A1
(43) Pub. Date: Apr. 10, 2014

(54) PHOTO EDITOR IN A MULTIFUNCTION PRINTER

(71) Applicant: Siow Kiat Tan, Singapore (SG)

(72) Inventor: Siow Kiat Tan, Singapore (SG)

(21) Appl. No.: 13/646,763

(22) Filed: Oct. 8, 2012

(51) Int. Cl. G06K 15/02

(52) U.S. Cl. 358/1.13

(57) ABSTRACT

A multifunction printer includes a printing apparatus; a scanning apparatus; a network connection; an embedded web server for monitoring or administering the multifunction printer through web pages that are accessible to a web browser on a client station through the network connection; a read only memory; and a photo editor application stored in the read only memory, wherein the photo editor application is configured to provide a browser-based user interface via the embedded web server for a user to view one or more images or perform editing tasks on the images.

### CROSS REFERENCE TO RELATED APPLICATIONS

Reference is made to commonly assigned, co-pending U.S. patent application Ser. No. ______ (K000838) by Siow Kiat Tan, filed concurrently herewith, entitled: “Game Server in a Multifunction Printer”, the disclosure of which is incorporated herein.

### FIELD OF THE INVENTION

The present invention relates to a multifunction printer having an embedded web server, and more particularly to providing a photo editor in such a multifunction printer.

### BACKGROUND OF THE INVENTION

In the past, printers were typically connected directly to a host computer or to a local network. With the proliferation of smart mobile devices such as smart phones and tablets, it has become advantageous to facilitate easy wireless connection between such smart mobile devices and multifunction printers for printing documents, monitoring printer status and other printing or scanning related tasks. To accomplish this, some multifunction printers now include embedded web servers. The primary function of a web server is to provide web pages to deliver user content on request to clients using the Hypertext Transfer Protocol (HTTP). The user runs a web browser to interact with web servers. Embedding a web server in a printer provides a rich user interface to configure and control the multifunction printer and view the printer status using the comparatively large screen on the smart mobile device. The user connects to the printer through the IP address of the printer by browsing to the URL of the printer.

A popular feature of smart mobile devices is the camera. In fact, since most users carry their smart mobile device essentially at all times, there is no need to carry a digital camera as well. As a result, users take many pictures on their smart mobile devices, either for their personal enjoyment or for sharing with other people. Very often such pictures can be improved by photo editing such as adjustment of brightness or contrast, or cropping or rotation or size adjustment. Although a photo editing app can be downloaded to the smart mobile device, it requires a separate download and may not be free. In addition, there are several tasks that such an app will not be readily able to do, especially in relation to a multifunction printer. These include editing a photo on a memory card in the multifunction printer's memory card slot; acquiring and editing a scanned image from the scanning apparatus of the multifunction printer; and uploading an edited photo to the printer directly for printing. For the latter task, a photo app would need to use another print path, which involves additional steps such as printer discovery, converting data to a suitable printer format, and using a suitable protocol to transfer data to a network port on the printer.

What is needed is a way to provide photo editing capability for smart mobile devices, as well as for other networked devices that can connect to a multifunction printer, in a way that permits easy use of the multifunction printer's functions without incurring additional cost to the user.

### SUMMARY OF THE INVENTION

The present invention is directed to overcoming one or more of the problems set forth above. Briefly summarized, according to one aspect of the invention, the invention resides in a multifunction printer comprising: a printing apparatus; a scanning apparatus; a network connection; an embedded web server for monitoring or administering the multifunction printer through web pages that are accessible to a web browser on a client station through the network connection; a read only memory; and a photo editor application stored in the read only memory, wherein the photo editor application is configured to provide a browser-based user interface via the embedded web server for a user to view one or more images or perform editing tasks on the images.

### BRIEF DESCRIPTION OF THE DRAWINGS

FIG. 1 is a perspective of a multifunction printer;

FIG. 2 is a schematic diagram showing how the different parts of the multifunction printer are related to one another and to external computers according to an embodiment of the invention; and

FIG. 3 is a block diagram showing how an example of a web page related to a photo editor in the multifunction printer can be displayed on a smart mobile device or network computer according to an embodiment of the invention.

### DETAILED DESCRIPTION OF THE INVENTION

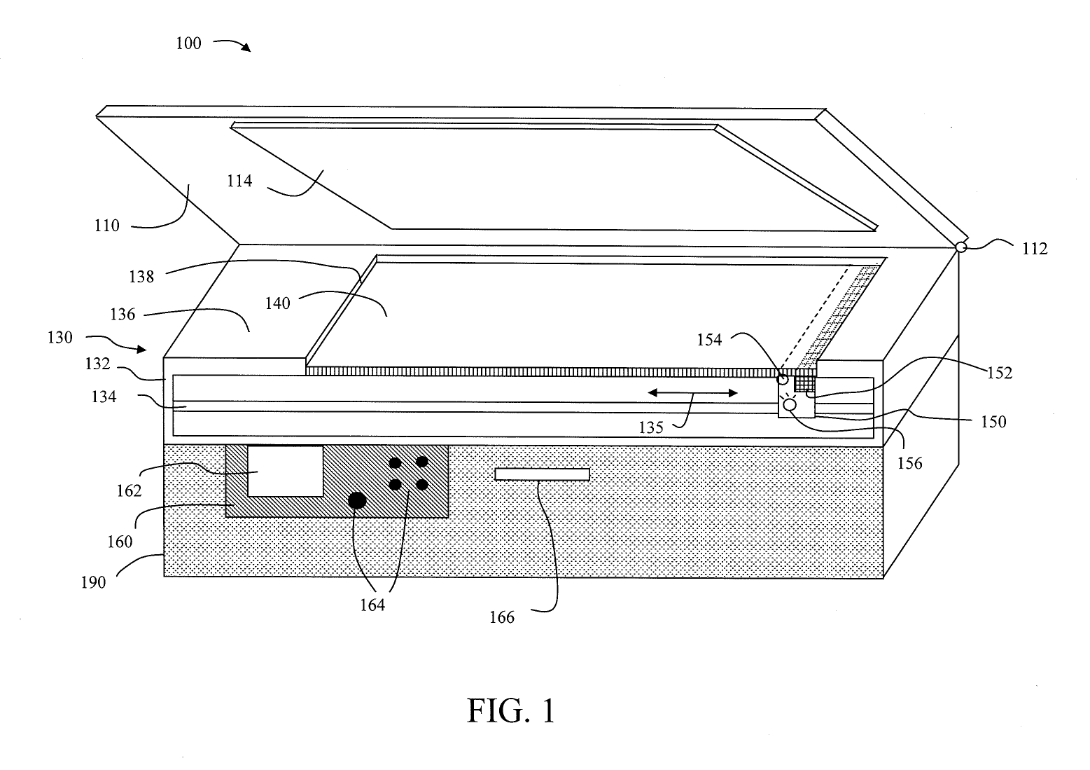

FIG. 1 shows a perspective of a multifunction printer 100 that can be used in embodiments of the invention. The multifunction printer 100 includes a scanning apparatus 130 for acquiring digitized images of documents or other objects, and a printing apparatus 190, which can be an inkjet printer for example. In this view, the front portion of the scanning apparatus 130 is cut away in order to show internal features of the scanning apparatus more clearly. The multifunction printer 100 can do printing, scanning of documents, or copying of documents (i.e. printing plus scanning).

A control panel 160 for the apparatus is shown in FIG. 1 as being located on the front of the printing apparatus 190, but this was done partly for illustrative purposes so as not to obscure features of the scanning apparatus 130. The control panel 160 can alternatively be located on the top or the front of the scanning apparatus 130 for example. The control panel 160 can include a display 162 and a variety of control buttons 164. For cases where the display 162 is a touch screen, the control buttons 164 can be integrated into the touch screen rather than being separate from it. Also shown is a memory reader 166 for reading memory devices such as memory cards or flash drives when they are inserted. Photos or other electronic images can be directly provided to the multifunction printer 100 through the memory reader 166.

The scanning apparatus 130 includes a scanning apparatus body 132 and a scanner lid 110, which is joined to the scanning apparatus body 132 by a hinge 112. The surface of the scanning apparatus body 132 that is covered by the scanner lid 110 when the scanner lid 110 is closed includes a frame 136. A transparent platen 140 (typically a flat piece of glass) is inset within the frame 136. In the example shown in FIG. 1, the surface of the transparent platen 140 is lower than the surface of the frame 136 so that there is an offset 138. The transparent platen 140 is not covered by the scanner lid 110 when the scanner lid 110 is open as it is in FIG. 1.

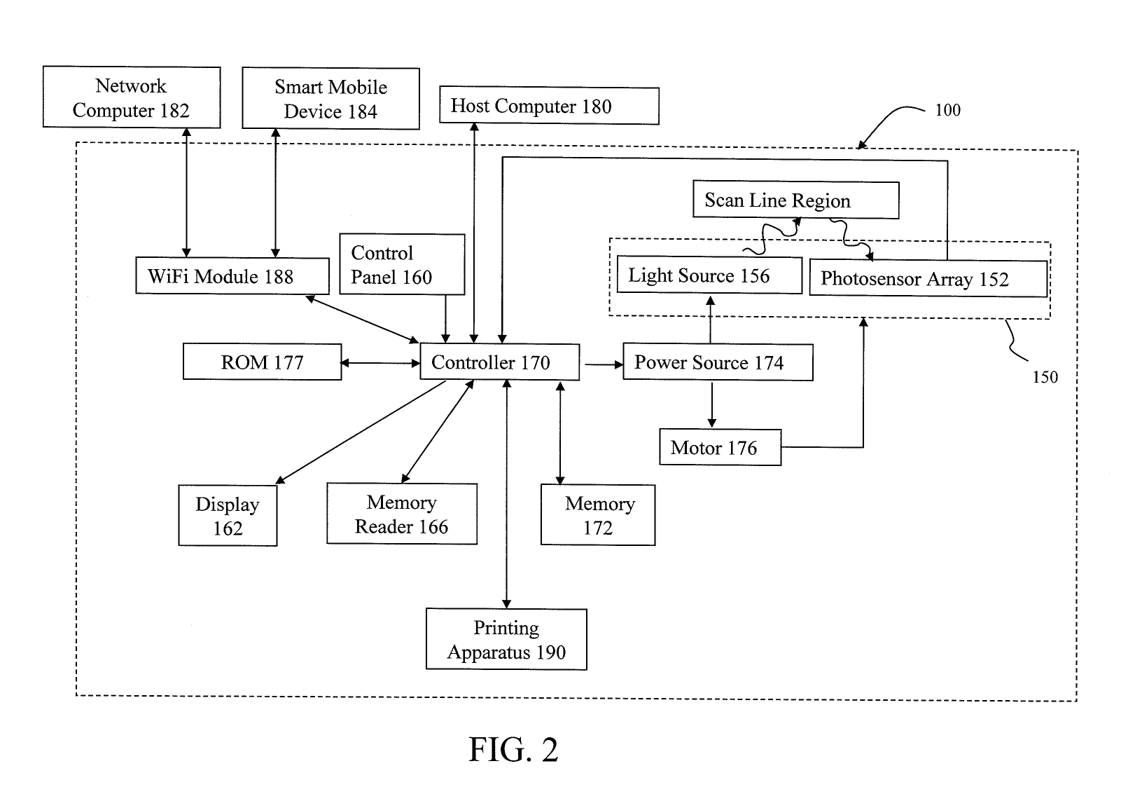

Below the transparent platen 140 is a movable sensor array module 150. In the example shown in FIG. 1, the movable sensor array module 150 includes a photosensor array (such as a contact image sensor) 152 extending the width of the transparent platen 140, a roller 154 that is biased into contact with the underside of the transparent platen 140, and a light source 156 that illuminates a scan line of a document or other item (not shown) that is placed on top of the transparent platen 140. A light guide and other optics (not shown) can also be included in the sensor array module 150. The sensor array module 150 is moved back and forth along a scanning guide 134 in a direction 135 across the length of the transparent platen 140 in order to scan the document or other item, receiving reflected light from the item through the transparent platen 140 scan line by scan line and converting the reflected light into electrical signals. A controller 170 (see FIG. 2) converts the electrical signals into digitized data to form a digitized image of the item. The scanning guide 134 can be a round rail, a rack and pinion or other guiding member that can use the power of a motor (not shown) to provide a linear motion along the scanning direction 135. In FIG. 1, the sensor array module 150 is parked in its home position near one end of the transparent platen 140. The home position is where the sensor array module 150 returns between scanning operations.

The scanner lid 110 includes a reflective backing plate 114. The thickness of the reflective backing plate 114 is accommodated in an offset 138 between the frame 136 and the top surface of the transparent platen 140 when the scanner lid 110 is closed. The reflective backing plate 114 can be resiliently mounted on the scanner lid 110, so that the reflective backing plate 114 is effective in pressing documents of various thicknesses against the transparent platen 140. Typically the reflective backing plate 114 is white in the document scanning region. Since many documents are printed on white paper, a white reflective backing plate 114 results in an overall white background even for documents of sizes that are smaller than the scanning region. For other types of objects to be scanned, such as photos, the white reflective backing plate 114 produces a clean background that provides good contrast for the photos. In other scanning apparatus designs, the reflective backing function is integrated into the scanner lid 110.

FIG. 2 schematically shows the relationship of components of the multifunction printer 100 and computers (such as a host computer 180 or a network computer 182) or a smart mobile device 184 that the multifunction printer 100 is connected. A user can initiate a printing or scanning operation from the control panel 160, or alternatively from the host computer 180 or the network computer 182 or the smart mobile device 184. For a scanning operation, for example, a signal is sent to the controller 170, which then sends a signal to a power source 174 to turn on the light source 156 and also to operate a motor 176 in order to move the sensor array module 150 along the scanning direction 135. As the sensor array module 150 is moved, light from the light source 156 reflects off a document or other object that is placed on the transparent platen 140, and impinges on the photosensor array 152 one scan line at a time. A scan line signal is sent from the photosensor array 152 to the controller 170 where it can be further processed before sending it to a memory 172 (or to the host computer 180 for example) in order to compose an entire scanned image signal, scan line by scan line. When the scan is completed, the controller 170 sends a signal to the power source 174 to send power to the motor 176 in order to return the sensor array module 150 to its home position. For printing or scanning operations initiated by the network computer 182 or the smart mobile device 184, data transmission to or from the controller 170 is done through a WiFi module 188.

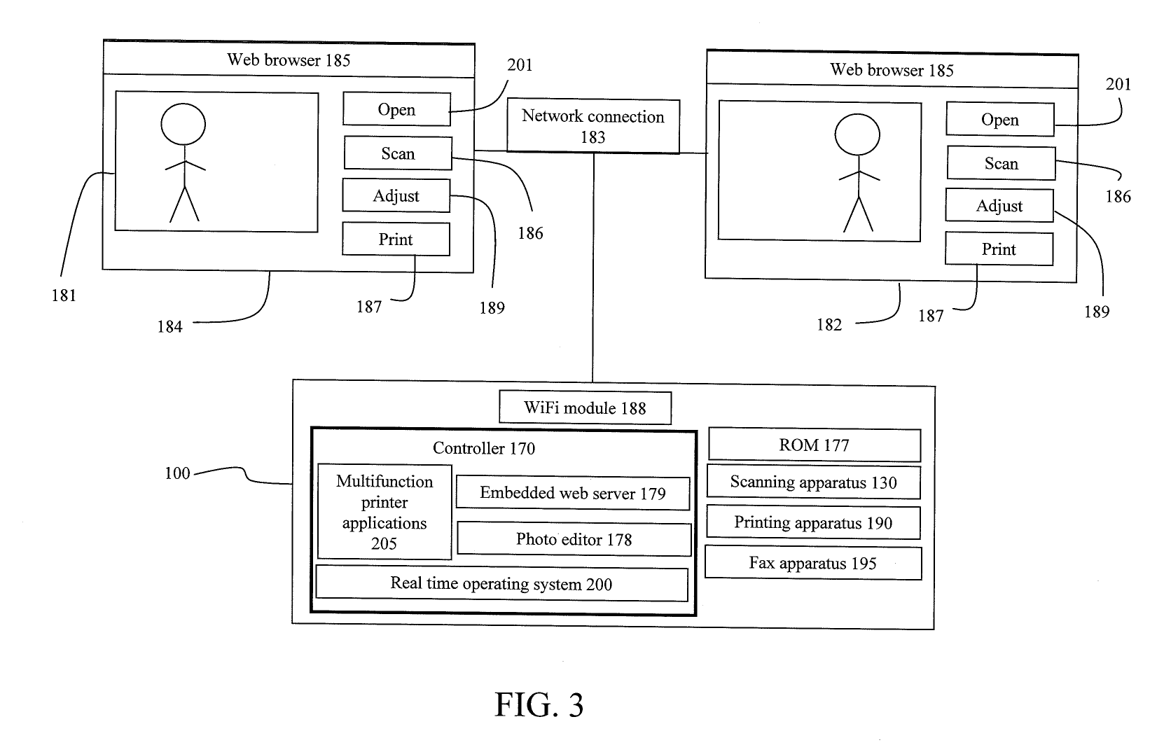

As shown in FIG. 3, embodiments of the present invention provide a photo editor 178 written in a device independent programming language, such as Javascript, and stored in a read only memory 177 (see FIG. 2 also). Because a device independent programming language is used, photo editor application 178 is able to execute on a wide variety of computing platforms, as long as the computing platform has a modern web browser. An embedded web server 179 provides web pages to a client station through a network connection 183 for monitoring and administering the multifunction printer 100. A user operating a client computing device, such as a network computer 182 or a smart mobile device 184 runs a web browser 185 and browses to the URL of the multifunction printer 100. The photo editor application 178 loads and runs on the web browser 185 without requiring additional software to be installed on the client computing device.

The photo editor application 178 provides a browser-based user interface via the embedded web server 179 for the user to view one or more images or perform editing tasks on them using the smart mobile device 184 or the network computer 182 (FIG. 2). For example, the photo editor application 178 can provide a soft control button Scan 186 for the user of a smart mobile device 184 or the network computer 182 to initiate a scan job on the scanning apparatus 130 and display the scanned output on a photo viewing window 181 of the smart mobile device 184 or the network computer 182. Further, the photo editor application 178 can provide a soft control button Open 201 for the user of a smart mobile device 184 or the network computer 182 to open a file and display the image on the photo viewing window 181 of the smart mobile device 184 or the network computer 182. The photo editor application 178 can provide a soft control button Adjust 189 for the user to perform image enhancement or transformation operations on the image displayed on the smart mobile device 184 or the network computer 182, such as changing the contrast, brightness, image size, and so on. When the user is satisfied with the final image, the user can save the image or click on a soft control button Print 187, and the image will be printed using the printing apparatus 190 of the multifunction printer 100. Optionally, the multifunction printer 100 also includes a fax apparatus 195, which can similarly be accessed by the smart mobile device 184 or the network computer 182. The controller 170 functions as a system manager and operates the various multifunction printer applications 205 as well the embedded web server 179 and the photo editor application 178 via a real time operating system 200.

Sources of images that can be viewed and edited by the photo editor application 178 include images stored on the host computer 180 (see FIG. 2) or the network computer 182 or the smart mobile device 184; images scanned on the scanning apparatus 130 of the multifunction printer 100; images read from a user-inserted memory card or flash drive the by memory reader 166 (FIG. 1); or images referenced as hyperlinks to a social networking site (not shown).

Providing the photo editor application 178 in the multifunction printer 100 having the embedded web server 179 has several advantages relative to installing the photo editor application 178 on the smart mobile device 184 or on the network printer 182, as well as relative to using an Internet photo editor web site implementation:

1. The photo editor application 178 in the multifunction printer 100 is accessible to client stations within the local network without having to access the Internet. This removes concern on data privacy and data usage costs.

2. The photo editor application 178 in the multifunction printer 100 is able to print images even if the client station does not have a suitable printer driver for the multifunction printer 100. It achieves this by accepting print content of the client station uploaded from the web browser 185 through the embedded web server 179.

3. The photo editor 178 in the multifunction printer 100 is able to optimize its print output for the destination recording media in terms of printable area and media type, for example, without user intervention. This is made possible because the web browser 185 has a bidirectional link with the embedded web server 179 and the printing apparatus 190, typically through the controller 170.

4. The scanning apparatus 130 in the multifunction printer 100 can provide its scan capability as an easy way to acquire and send one or more images through the web browser 185 to the smart mobile device 184 or the network computer 182 for editing using the photo editor 178.

5. The user does not need to purchase or install a separate application on each computing device for image editing. Multiple client computing devices (including the smart mobile devices 184 and the network computers 182) can access the photo editor application 178 independently.

6. The user can update the photo editor application 178 by updating the firmware for multifunction printer 100 or by updating internal or external resources for the embedded web server 179.

The present invention has been described in detail with particular reference to certain preferred embodiments thereof, but it will be understood that variations and modifications can be effected within the spirit and scope of the invention.

### PARTS LIST

100 Multifunction printer
110 Scanner lid
112 Hinge
114 Reflective backing plate
130 Scanning apparatus
132 Scanning apparatus body
134 Scanning guide
135 Scanning direction
136 Frame
138 Offset (for reflective backing plate)
140 Transparent platen
150 Sensor array module
152 Photosensor array
154 Roller of sensor array module
156 Light source
158 Light guide
160 Control panel
162 Display
164 Control buttons
166 Memory reader
170 Controller (system manager)
172 Memory
174 Power source
176 Motor
177 Read Only Memory (ROM)
178 Photo editor application
179 Embedded web server
180 Host computer
181 Photo viewer window
182 Network computer
183 Network connection
   Parts List (con't)
184 Smart mobile device
185 Web browser
186 Scan button
187 Print button
188 WiFi module
189 Adjust button
190 Printing apparatus
195 Fax apparatus
200 Real time operating system
201 Open button
205 Multifunction printer applications

1. A multifunction printer comprising:
a printing apparatus;
a scanning apparatus;
a network connection;
an embedded web server for monitoring or administering the multifunction printer through web pages that are accessible to a web browser on a client station through the network connection;
a read only memory; and
a photo editor application stored in the read only memory, wherein the photo editor application is configured to provide a browser-based user interface via the embedded web server for a user to view one or more images or perform editing tasks on the images.

2. The multifunction printer of claim 1, wherein the photo editor application is written in a device independent programming language.

3. The multifunction printer of claim 1, wherein the photo editor application is configured to be accessible to client stations within a local network without requiring the client stations to access the Internet.

4. The multifunction printer of claim 1, wherein the multifunction printer is configured to accept print content uploaded from the web browser of the client station through the embedded web server.

5. The multifunction printer of claim 4, wherein print output of the printing apparatus corresponding to the print content from the web browser is configured to be optimized according to size or type of recording medium in the printing apparatus without user intervention.

6. The multifunction printer of claim 1, wherein the embedded web server is configured to send HTML, images and other web page resources to the client station through the web browser.

7. The multifunction printer of claim 1, wherein the scanning apparatus is configured to acquire one or more images for sending to the client station and the photo editor application is configured to view and edit images acquired by the scanning apparatus.

8. The multifunction printer of claim 6 further comprising a reader for a user-inserted memory storage device, wherein the photo editor application is configured to view and edit images from the user-inserted memory storage device.

9. The multifunction printer of claim 1, wherein the photo editor application is updatable through a firmware update of the multifunction printer.

10. The multifunction printer of claim 1, wherein the photo editor application is configured to view and edit images referenced as hyperlinks to a social networking site or other Internet web site.

11. The multifunction printer of claim 1, wherein the photo editor application is configured to view and edit images uploaded by networked client stations via the embedded web server.
